(19) United States
(12) Patent Application Publication
(10) Pub. No.: US 2019/0180375 A1
(43) Pub. Date: Jun. 13, 2019

(54) Financial Risk Forecast System and the Method Thereof

(71) Applicant: Seth Haoting Huang, Taipei City (TW)

(72) Inventors: Seth Haoting Huang, Taipei City (TW); Rachid Ait Seddik, Taipei City (TW)

(21) Appl. No.: 16/214,209

(22) Filed: Dec. 10, 2018

Related U.S. Application Data
(60) Provisional application No. 62/597,546, filed on Dec. 12, 2017.

(51) Int. Cl. G06Q 40/06; G06N 3/04; G06N 3/08

(52) U.S. Cl. CPC G06Q 40/06; G06N 3/084; G06N 3/0445

(57) ABSTRACT

This specification discloses a financial risk forecast system and the method thereof with artificial intelligence. The mentioned financial risk forecast system and the method can uses multi-layer perception (deep neural network) and recurrent neural network model structure to generate more accurate risk predictions for financial instruments. According to this specification, financial institutions can efficiently structure portfolios that incorporate the potential increase/decrease of future instrument volatilities and appropriate hedging/diversification.

### BACKGROUND OF THE INVENTION

### 1. Field of the Invention

The present invention is generally related to a financial forecast system and the method thereof, and more particularly to a financial forecast system and the method thereof with artificial intelligence.

### 2. Description of the Prior Art

Financial investment is a general art in human's life. People always hope to increase their property through investment. Risks in investing world are everywhere, and some people are successfully increased their properties through investment while others unsuccessfully. In order to raise the investment opportunity, how to forecast risks in financial investment is an important lesson.

To one skilled in this art, volatility is a common tool for risk forecast. Through observing and calculating historical volatilities, a trend of the target financial investing goods can be calculated. And the forecast of the target financial investing goods is produced therefrom. Basically, excluding future accidents, using historical volatilities is a good solution for forecasting the wanted trend. However, the “risk” of the mentioned forecast is how to tweak the parameter in the calculation and how many historical data taken in the calculation. A mistake risk forecast could cause properties lost and financial crashed. Especially, the invest scale of financial institutions is usually much larger than the invest scale of individual investors, so that financial institutions need more efficiently and more accurately financial risk forecast information to avoid properties lost.

In view of the above matters, developing a novel financial risk forecast system and the method thereof with artificial intelligence having the advantage of accurately avoiding financial risk is still an important task for the industry.

### SUMMARY OF THE INVENTION

In light of the above background, in order to fulfill the requirements of the industry, the present invention provides a novel financial risk forecast system and the method thereof with artificial intelligence having the advantage of more accurately prediction.

One objective of the present invention is to provide a financial risk forecast system and the method thereof with artificial intelligence to generate comparable risk forecasts for any given data of financial instruments through inputting historical data into AI models produced by recurrent neural network.

Another objective of the present invention is to provide a financial risk forecast system and the method thereof with artificial intelligence to generate comparable risk forecasts with accurate result through inputting historical data into AI models produced by recurrent neural network.

Still another objective of the present invention is to provide a financial risk forecast system and the method thereof with artificial intelligence to generate more accurately risk forecasts results through employing a plurality of AI models produced by recurrent neural network.

Accordingly, the present invention discloses a financial risk forecast system and the method thereof with artificial intelligence. The mentioned financial risk forecast method, for a financial risk forecast system with artificial intelligence, comprises the process of collecting and building data repository, building and training a plurality of artificial intelligence models, saving and employing the artificial intelligence models past back-testing to generate risk prediction. The mentioned financial risk forecast system and the method thereof can be used to generate comparable risk forecast results for any financial instruments. According to this present invention, a plurality of artificial intelligence models is built by recurrent neural network from historical data. Those artificial intelligence models are undergone the process of testing and at least one back-testing for filtering out the best performing artificial intelligence models close to financial instruments. Lastly, the best performing artificial intelligence models are employed to generate future volatility predictions of financial instruments, and to generate the risk forecast results of financial instruments. Based on the result, financial institutions, or any investors, can efficiently structure portfolios that incorporate the potential increase/decrease of future instrument volatilities and appropriate hedging/diversification.

### BRIEF DESCRIPTION OF THE DRAWINGS

The present disclosure can be described by the embodiments given below. It is understood, however, that the embodiments below are not necessarily limitations to the present disclosure, but are used to a typical implementation of the invention.

FIG. 1 shows a financial risk forecast system with artificial intelligence of this invention;

FIG. 2 shows a flowchart of a financial risk forecast method with artificial intelligence of this invention;

FIG. 3 shows an example of a financial risk forecast system with artificial intelligence of this invention;

FIG. 4A to 4D show a block diagram of an example of a financial risk forecast method with artificial intelligence of this invention;

FIG. 5 shows an example of a cumulative returns graph of a portfolio of the financial risk forecast system with AI models of this invention and passive market benchmark/S&P500;

FIG. 6 shows an example of volatility graph of volatility prediction of the financial risk forecast system with AI models of this specification versus real market volatility;

FIG. 7 shows an example of the graph of aggregation of the model losses of this invention;

FIG. 8 shows an example of performing validation on the AI models of the financial risk forecast system with AI models of this specification;

FIG. 9 shows an example of a table of comparing the model loss on the “test data-true performance” for each model of the AI models of the financial risk forecast system with AI models of this specification and the base models;

FIG. 10 shows the graph of the volatility AI prediction of the financial risk forecast system with AI models of this specification and the actual volatility;

FIG. 11A and FIG. 11B respectively show the graph of volatility of AI models output based on the same data set versus actual volatility;

FIG. 11C shows an example of the graph of the volatility prediction of basic encoder versus actual volatility of a financial instrument; and

FIG. 11D demonstrates the graph depicting an ensemble prediction performance of the financial risk forecast system with AI models of this specification against the actual performance of financial instrument volatility.

### DESCRIPTION OF THE PREFERRED EMBODIMENTS

What probed into the invention is a financial risk forecast system and the method thereof with artificial intelligence. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

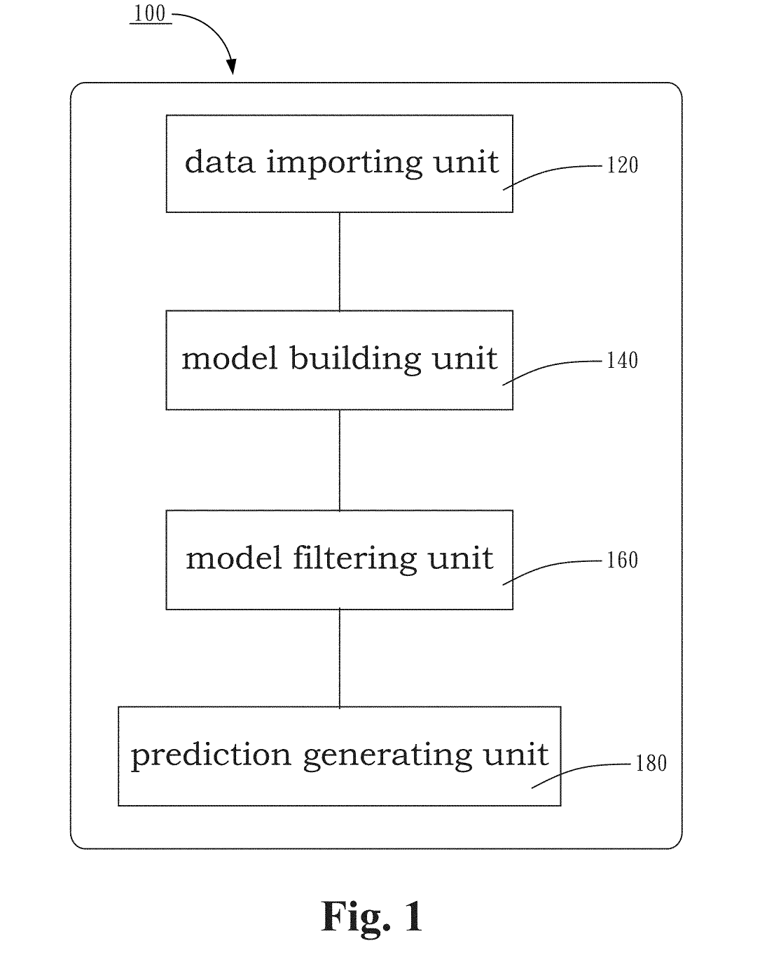

One preferred embodiment according to this specification discloses a financial risk forecast system with artificial intelligence. FIG. 1 shows a financial risk forecast system with artificial intelligence of this embodiment. Referred to FIG. 1, the mentioned financial risk forecast system 100 comprises a data importing unit 120, a model building unit 140, a model filtering unit 160, and a prediction generating unit 180.

According to this embodiment, the data importing unit 120 is employed for collecting data and building a data repository based on the data. According to this embodiment, the data in the data repository is processed into a unified format. And, the features of the data are extracted in the data importing unit 120. In one preferred example of this embodiment, the data is collecting from multiple sources selected from one or the combination of the group consisted of: adjusted historical data, fundamental data, macro data, live feeds, financial reports, social media data, and satellite images. Each of these data categories should be maintained up to date and clear of different types of biases, and be used for storage at the data importing unit 120.

The model building unit 140 is employed to build a plurality of artificial intelligence models based on the features of the data of the data repository in the data importing unit 120. The mentioned artificial intelligence models can be constructed from one of the group consisted of: RNN (recurrent neural networks), LSTM (long-short term memory), feed forward network, CNN (convolutional neural networks), and other artificial neural networks known by the one skilled in the art. In one preferred example of this embodiment, the mentioned features are selected from one or the combination of the group consisted of: price movements, covariances, and product characteristics. In one preferred example of this embodiment, the output of the artificial intelligence models is a time series of observations. In one preferred example of this embodiment, the output of the artificial intelligence models can be sliced into training, validation, and testing data for the artificial intelligence models. In one preferred example of this embodiment, the mentioned artificial intelligence models can also be trained in the model building unit 140. The mentioned artificial intelligence models are trained with the data with unified format from the data importing unit 120. The mentioned artificial intelligence models can be trained by the methodologies selected from at least one of the group consisted of: Adam Optimization Algorithm, back propagation, and other techniques/methodologies known by the one skilled in the art.

The model filtering unit 160 is employed for filtering the artificial intelligence models in the model building unit 140. In the model filtering unit 160, the mentioned artificial intelligence models are tested with multiple techniques and methodologies. In one preferred example of this embodiment, the mentioned artificial intelligence models can be tested with data collected in new time period. Those artificial intelligence models generated worst testing results in the mentioned testing are filtered out and are deleted. After the testing, those artificial intelligence models past the mentioned testing are going to a tweaking parameter process for tweaking parameters of those artificial intelligence models based on their generated testing results in the mentioned testing. In one preferred example of this embodiment, the mentioned tweaking parameter process will also adjust hyper parameters of those artificial intelligence models based on their generated testing results in the mentioned testing in order to yield a better accuracy in the testing result. After tweaking parameter and adjusting hyper parameter, at least one back-testing is performed on the artificial intelligence models with new testing data. After each back-testing, the artificial intelligence models generated worst testing results are deleted, and the parameters tweaking and the hyper parameters adjusting, based on the back-testing results, are implemented on the at least one artificial intelligence models past the back-testing. After at least one back-testing, the at least one best performing artificial intelligence models, wherein the best performing artificial intelligence models are past the at least one back-testing, and parameter tweaking/hyper parameter adjusting, are saved in the model filtering unit 160. In one preferred example of this embodiment, only recent at least one artificial intelligence models past the back-testing and parameter tweaking are kept in the model filtering unit 160, and the older artificial intelligence models past the back-testing are periodically removed from the model filtering unit 160.

In the prediction generating unit 180, the at least one best performing artificial intelligence models saved in the model filtering unit 160 are reloaded and used for generating prediction based on the input financial instrument request. In one preferred example of this embodiment, after inputting universe and target products, a requested prediction result gets generated from the best performing artificial intelligence models saved in the model filtering unit 160.

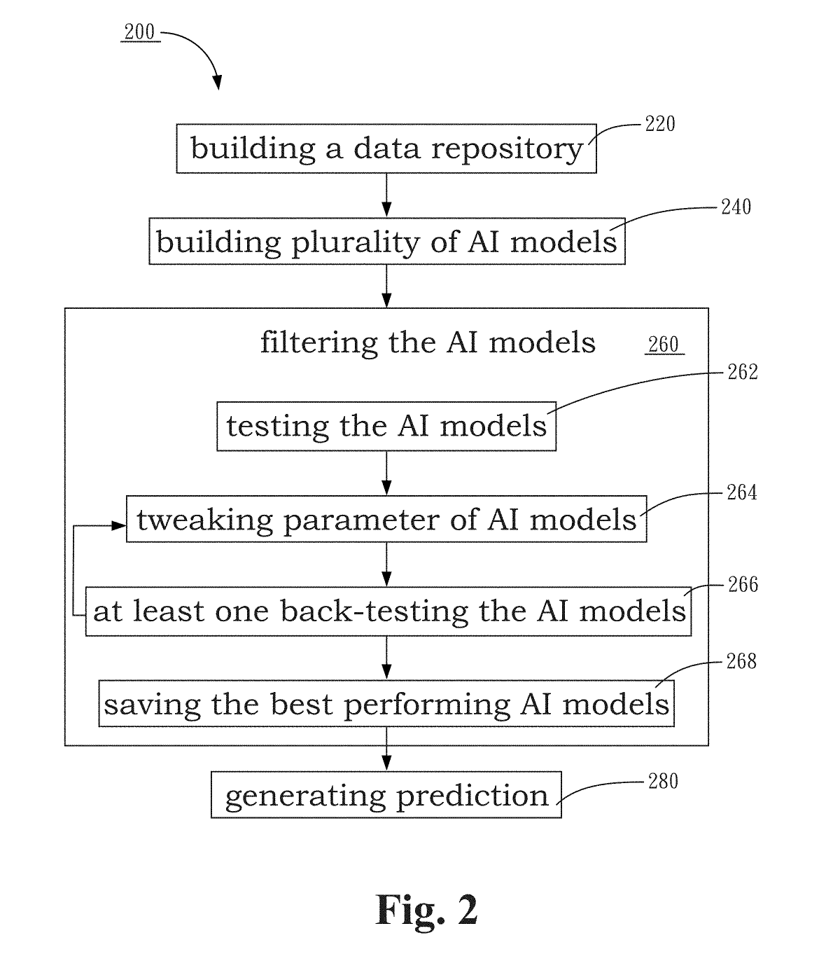

Another preferred embodiment according to this specification discloses a financial risk forecast method with artificial intelligence. The mentioned financial risk forecast method with artificial intelligence can be used for a financial risk forecast system. FIG. 2 shows a financial risk forecast method with artificial intelligence of this embodiment. Referred to FIG. 2, the mentioned financial risk forecast method 200 comprises a step 220 of building data repository, a step 240 of building a plurality of artificial intelligence (AI) models, a step 260 of filtering artificial intelligence models, and a step 280 of generating prediction.

In the step 220, data from multiple data sources is collected for building data repository. In one preferred example of this embodiment, the data sources are selected from one or the combination of the group consisted of: adjusted historical data, fundamental data, macro data, live feeds, financial reports, social media data, and satellite images. Each of these data categories should be maintained up to date and clear of different types of biases. In one preferred example of this embodiment, the relational databases could be used for storage at the data repository. According to this embodiment, the data in the data repository is processed into a unified format. And, the features of the data are extracted in the step 220 of building data repository.

In the step 240, the features of the data of the data repository is employed for building a plurality of artificial intelligence models. In one preferred example of this embodiment, the mentioned a plurality of artificial intelligence models can be built with one feature of the data of the data repository. In another preferred example of this embodiment, the mentioned a plurality of artificial intelligence models can be built with a plurality of features of the data of the data repository. The mentioned artificial intelligence models can be constructed from one of the group consisted of: RNN (recurrent neural networks), LSTM (long-short term memory), feed forward network, CNN (convolutional neural networks), and other artificial neural networks known by the one skilled in the art. In one preferred example of this embodiment, the mentioned features are selected from one or the combination of the group consisted of: price movements, covariances, and product characteristics. In one preferred example of this embodiment, the output of the artificial intelligence models is a time series of observations. In one preferred example of this embodiment, the output of the artificial intelligence models can be sliced into training, validation, and testing data for the artificial intelligence models. The mentioned artificial intelligence models can be trained in the mentioned steps 240. In one preferred example of this embodiment, the mentioned artificial intelligence models are trained with the data with unified format from the steps 220. The mentioned artificial intelligence models can be trained by the methodologies selected from at least one of the group consisted of: Adam Optimization Algorithm, back propagation, and other techniques/methodologies known by the one skilled in the art.

After building the artificial intelligence models in the step 240, the step 260 is carried out for filtering the mentioned artificial intelligence models. According to this embodiment, the step 260 comprises the following steps: a step 262 for testing the mentioned artificial intelligence models, a step 264 for tweaking parameters of each of the artificial intelligence models, a step 266 for performing at least one back-testing on the artificial intelligence models, and a step 268 saving the best performing artificial intelligence models. In the step 262, the mentioned artificial intelligence models are tested with multiple techniques and methodologies. In one preferred example of this embodiment, the mentioned testing in the step 262 can be using “new historical data” in different time period for testing the artificial intelligence models. After the testing in the step 262, those artificial intelligence models generated worst testing results in the testing are filtered out and are deleted. In one preferred example of this embodiment, the mentioned “those artificial intelligence models generated worst testing results” is that the deviations between the testing results of those artificial intelligence models and the data used in the testing are larger than default threshold value. After the step 262, the step 264 is going to tweak parameters of each of the plurality of artificial intelligence models past the mentioned testing. In one preferred example of this embodiment, the step 264 is also going to adjust hyper parameters of those artificial intelligence models past the testing in step 262 in order to yield a better accuracy in the testing results. In the step 264, those artificial intelligence models are tweaked parameters/adjusted hyper parameters based on their testing results, and a plurality of artificial intelligence models with tweaked parameters is obtained.

Subsequently, in the step 266, a plurality of artificial intelligence models with tweaked parameters/and adjusted hyper parameters are performed at least one beck-testing with new testing data. After every back-testing, those artificial intelligence models with tweaked parameters/and adjusted hyper parameters generated worst back-testing data in the back-testing are filtered out and are deleted. In one preferred example of this embodiment, the mentioned “those artificial intelligence models with tweaked parameters/and adjusted hyper parameters generated worst back-testing results” is that the deviations between the back-testing results of those artificial intelligence models with tweaked parameters/and adjusted hyper parameters and the data used in the back-testing are larger than default threshold value. Each of those artificial intelligence models past the back-testing are performed another parameters tweaking and hyper parameters adjusting based on the respective back-testing result. In other words, there can be a loop between the step 264 and the step 266. In the step 268, the best performing artificial intelligence models, wherein the best performance artificial intelligence models are the a plurality of artificial intelligence models past testing, back-testing, and tweaking parameter/adjusting hyper parameter, are saved.

In the step 280, for generating prediction, the mentioned best performing artificial intelligence models saved in the step 268 are reloaded and used. In one preferred example of this embodiment, when inputting universe and target products, a corresponding prediction gets generated from the mentioned best performing artificial intelligence models.

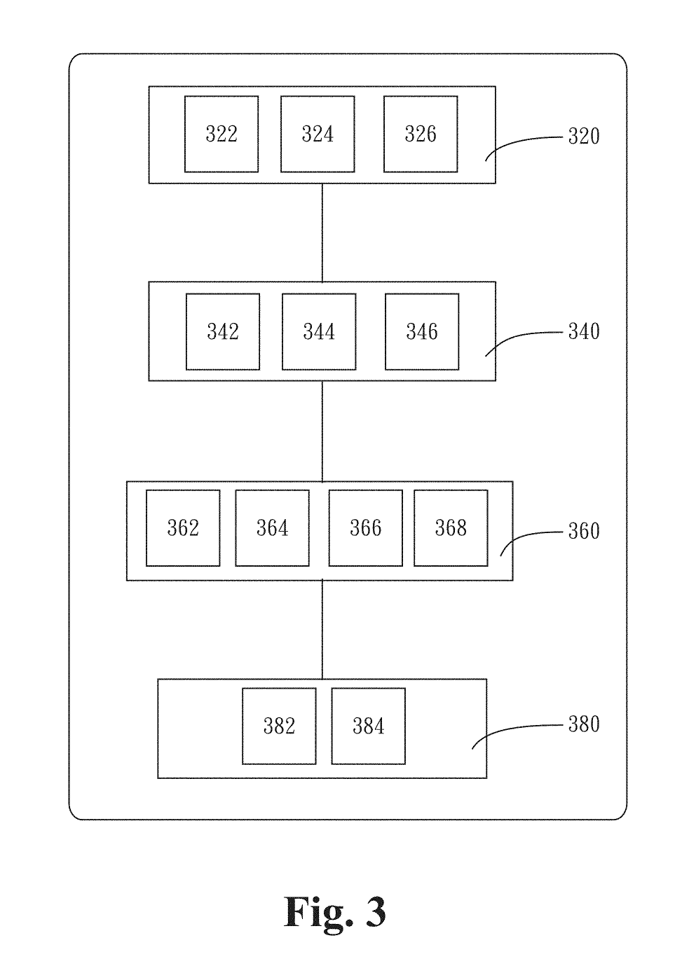

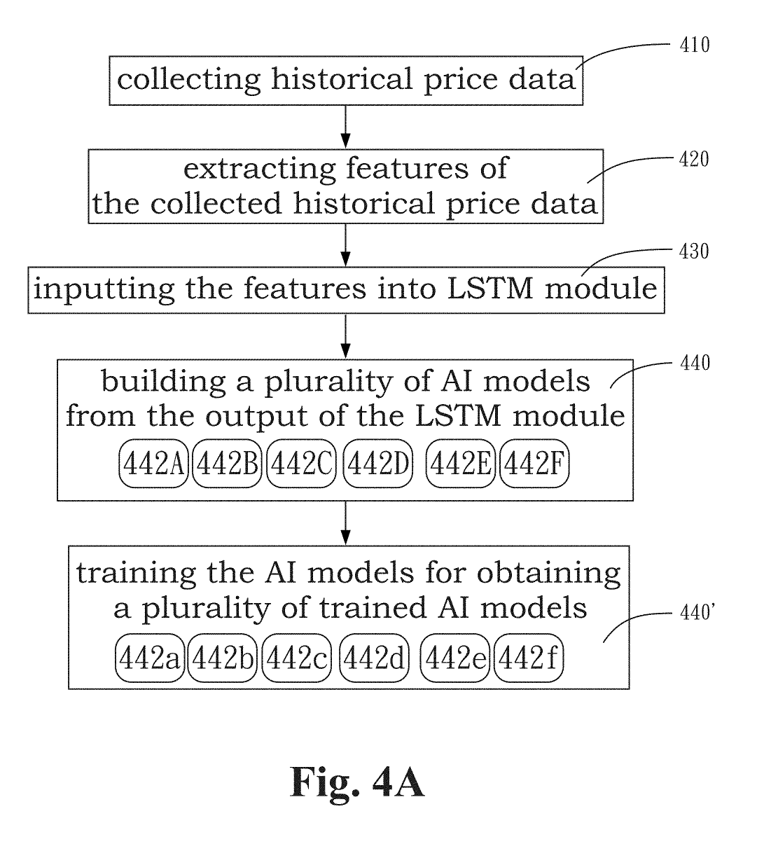

In one preferred example of this application, the financial risk forecast system and the method thereof with artificial intelligence can be used for financial instrument risk forecast with historical price data, as shown in FIG. 3 and FIGS. 4A-4D. FIG. 3 shows a financial risk forecast system of this example. FIGS. 4A-4D show flowcharts of a financial risk forecast method of this example.

Firstly, the data collecting module 322 of the data importing unit 320 is used for collecting historical price data of financial instruments. The mentioned historical price data is used for creating the data repository, as shown in the step 410. The mentioned historical price data can be imported into the data importing unit 320 by user, or can be automatically collected from internet by the data collecting module 322 according to default condition. In this example, the data collecting module 322 is going to keep collecting data and maintaining the data in the data repository 324 up to date. Including collecting historical price data, the data importing unit is going to process the collected historical price data into a unified format, and extract the features of the collected historical price data with a feature extracting module 326, as shown in the step 420. The mentioned features extracted from the collected historical price data can be storage in the data repository 324.

The features extracted from the collected historical price data are transported to a long-short term memory module (hereinafter referred to as LSTM module) 342 in model building unit 340. The features extracted from the collected historical price data can be used as the input of the LSTM module 342, as shown in the step 430. The output of the LSTM module 342 can be used to build a plurality of artificial intelligence models (herein after referred to as AI models), as 442A-442F shown in the step 440. It should be noticed that the number of the AI models is for instance, and is not for limiting this application. In one preferred operation of this example, the input of the LSTM module 342 can be a plurality of the mentioned features for building a plurality of AI models of multiple groups for the following testing, back-testing, and prediction generating. In order to simplify the illustration of this example, one of the mentioned features, historical price data, is employed as the input of the LSTM module 342 in the following.

Before performing the mentioned testing, the plurality of AI models can be trained by optimization methodologies in an optimizing module 344 for obtaining a plurality of trained AI models 442a˜442f, as shown as 440′ in FIG. 4A. In this present example, Adam Optimization Algorithm can be used in the optimizing module 344 for training the plurality of AI models and producing a plurality of trained AI models. The mentioned plurality of trained AI models 442a˜442f can be saved in a saving module 346 of the model building unit 340.

The plurality of trained AI models 442a˜442f are transported to a model filtering unit 360 for multiple times of testing and parameter tweaking, and a plurality of AI models closing to the historical price data will be generated in the model filtering unit 360. In the model filtering unit 360, a model testing module 362 is going to employ “new historical price data” for testing the plurality of trained AI models, as the step 450 shown in FIG. 4B. In one case of this present example, the mentioned “new historical price data” can be historical price data in new time period collected after the AI models built. In another case of this example, the mentioned “new historical price data” can be historical price data in different time period, such as historical price data in larger time period, collected after the AI models built. In the testing, if the deviations between the testing results of those AI models and the data used in the testing are larger than default threshold value, those AI models are not past the testing. Those AI models not past the testing, as 442c 442e in the step 452 shown in FIG. 4B, will be deleted. The plurality of AI models past the testing, as 442a, 442b, 442d, and 442e shown in the step 454 in FIG. 4B, is kept. A parameter tweaking module 364 is used for tweaking parameters of each of the plurality of AI models past the mentioned testing/and adjusting hyper parameters of each of the plurality of AI models past the mentioned testing individually based on the testing results generated by the plurality of AI models for obtaining a plurality of AI models with tweaked parameter, as 442a′, 442b′, 442d′, and 442f′ in the step 454′ shown in FIG. 4B.

The plurality of AI models with tweaked parameter a transported to a back-testing module 366 in the model filtering unit 360. And, another batch of “new historical price data” is employed for back-testing the plurality of AI models with tweaked parameter, as the step 460 shown in FIG. 4C. After the back-testing, if the deviations between the back-testing results of those AI models with tweaked parameter and the data used in the back-testing are larger than default threshold value, those AI models with tweaked parameter are not past the back-testing. Those AI models with tweaked parameter not past the back-testing, as 442d′ shown in the step 462 in FIG. 4C, will be deleted. The plurality of AI models with tweaked parameter past the back-testing is kept, as 442a′, 442b′, and 442f′ shown in the step 464 in FIG. 4C. The parameter tweaking module 364 is used for tweaking parameters of each of the plurality of AI models past the mentioned back-testing/and adjusting hyper parameters of each of the plurality of AI models past the mentioned back-testing individually based on the back-testing results generated by the plurality of AI models for obtaining a plurality of AI models with tweaked parameter, as 442a″, 442b″, and 442f″ in the step 464′ shown in FIG. 4C. And, still another batch of “new historical price data” can be used for performing second back-testing on the mentioned plurality of AI models with tweaked parameter 442a″, 442b″, and 442f″. Those AI models not past the second back-testing will be deleted, as AI model 442f″ as shown in the step 472 in FIG. 4C. The plurality of AI models past the second back-testing, such as 442a″, and 442b″ in the step 474 in FIG. 4C, is going to be saved in a best model saving module 368, as shown as the step 480 in FIG. 4C. According to this example, before saving in to the best model saving module 368, the parameter tweaking module 364 can be used for tweaking parameters of each of the plurality of AI models past the mentioned second back-testing/and adjusting hyper parameters of each of the plurality of AI models past the mentioned second back-testing individually based on the second back-testing results generated by the plurality of AI models, not shown in FIG. 4C. In this present example, in order to simplify the illustration, there are only two back-testing before saving the best AI models. In actual operation, there can be multiple back-testing performed before saving the best AI models for producing the best AI models more approaching the trend of the real historical price data.

According to this example, user can input prediction request of financial instruments into a user inputting interface 382 of a prediction generating unit 380, as shown in the step 492 of FIG. 4D. The mentioned prediction request can be any prediction that the user wants to know about the trend of the financial instruments. According to this example, the mentioned prediction request can be financial instrument item, risk factor, weighted ratio, or other requests known by the one skilled in that art. In this example the mentioned prediction generating unit 380 comprises user inputting interface 382, and user outputting interface 384. The mentioned user inputting interface 382 can be keyboard, pointed device, graphical user interface, or other inputting interface known by the one skilled in that art. When the financial risk forecast system of this example receiving the mentioned prediction request, the plurality of AI models saved in the best model saving module 368 is going to be reloaded, such as the AI models 442a″ and 442b″ in the step 494 shown in FIG. 4D. The plurality of AI models reloaded from the best AI model saving module 368 will be employed for generating the requested financial instrument risk prediction result, as shown in the step 496 in the FIG. 4D. After generating, the requested financial instrument risk prediction result will be transported to the user outputting interface 384 of the prediction generating unit 380. The mentioned user outputting interface 384 can be a displaying device. The mentioned financial instrument risk prediction result can be graphic mode, string mode displayed on the user outputting interface 384.

According to this example, for training the plurality of AI models, a sequence of inputs (xₜ) are given to the AI models.

X={x₁,x₂, . . . xₜ, . . . x_{T}}

The input xₜ, presents activations of N layers of the RNN (hₜ⁰, hₜ⁰, . . . , hₜ^{N}) using in the transformation. The hidden layer incorporates multiple states:

hₜⁱ=σ(Wₕⁱₕⁱ⁻¹hₜⁱ⁻¹+Wₕⁱhⁱhₜ₋₁ⁱ+bₕⁱ))

wherein hₜ⁰=xₜ.

the AI model prediction of this example is:

yₜ=Softmax(W_{hNy}hₜ^{N}+bₕ^{N})

hₜⁱ=σ(Wₕⁱₕⁱ⁻¹hₜⁱ⁻¹+Wₕⁱₕⁱhₜ₋₁ⁱ+bₕⁱ)

wherein hₜ⁰=xₜ.

In one preferred operation of this example, the softmax layer is adopted for the simplicity and stable interpretation of the outputs. If the output is singular, the softmax layer is going to be removed. The mentioned training calculates the loss log cross-entropy Lₜ between the predicted label and the actual label. Then, the financial risk forecast system propagates the loss by using Adam Optimization Algorithm. Adam Optimization Algorithm is not commonly used for financial modeling but has the advantage of adaptive learning rates.

When the selected AI models past 60% accuracy threshold, the financial risk forecast system proceeds to make prediction on the absolute average range for future periods.

Before using time T, pattern extractions are performed from the input of the data, non-random, non-shuffled sample. The data/information is transported to the trained models for generating predictions y_{T+1}. Then y_{T+1} is used as the next input (x_{T+2}) and repeat the process.

As known by one skilled in that art, a common drawback of RNNs (or deep neural network in general) is vanishing and exploding gradient. Vanishing gradient is when the gradient is too small, and resulting in poor learning. The exploding gradient causes very large gradients making the computations very unstable, rendering predictions unreliable. The financial risk forecast System in this example adopts a special network Long-Short-Term Memory (LSTM) wherein LSTM is helpful in gradient clipping. This means the network arbitrarily can lower the gradient if the gradient is greater than a default value. Through adopting this technique, the trained models should have higher reliability.

Additionally, LSTM theoretically retains a better long-term memory than typical RNN networks. LSTM models do not only have both long-term memory and short-term memory, but also can be used to descend the gradient for preventing vanishing gradient in an elegant way.

LSTM can be used to replace hidden layer of RNN that comprises different models. LSTM architecture comprises 4 main components: input gate (i), forget gate (f), output gate (o) and memory cell (c). As it is obvious from the names, it uses a gated architecture. Each gate as a specific purpose. For each input, gates decide the input quantity.

Besides LSTM, the hidden layer output can be kept similar to RNNs. The higher-level abstraction is similar to the conventional deep neural network structure. Feed an input xₜ, calculate hidden layer activations (hₜ⁰, hₜ⁰, . . . , hₜ^{N}), predict the output (yₜ), calculate the loss (Lₜ) and finally backpropagate the loss through the network. The backpropagation would change as LSTMs employ various architectures with more connections.

For calculating hidden layer activations, the financial risk forecast system operates inside the LSTM to one of these operations like reading input/writing.

iₜ=σ(Wₓⁱₓₜ+Wₕᵢₕₜ₋₁+bᵢ)

fₜ=σ(Wₓⁱf^{xt}+W_{hf}^{ht-1}+b_{f})

cₜ=σfₜcₜ₋₁+iₜ tan h(W_{xc}xₜ+W_{hc}hₜ₋₁+b_{c})

σₜ=σ(Wₓₒxₜ+Wₕ₀hₜ₋₁+bₒ)

hₜ=σₜ tan h(cₜ)

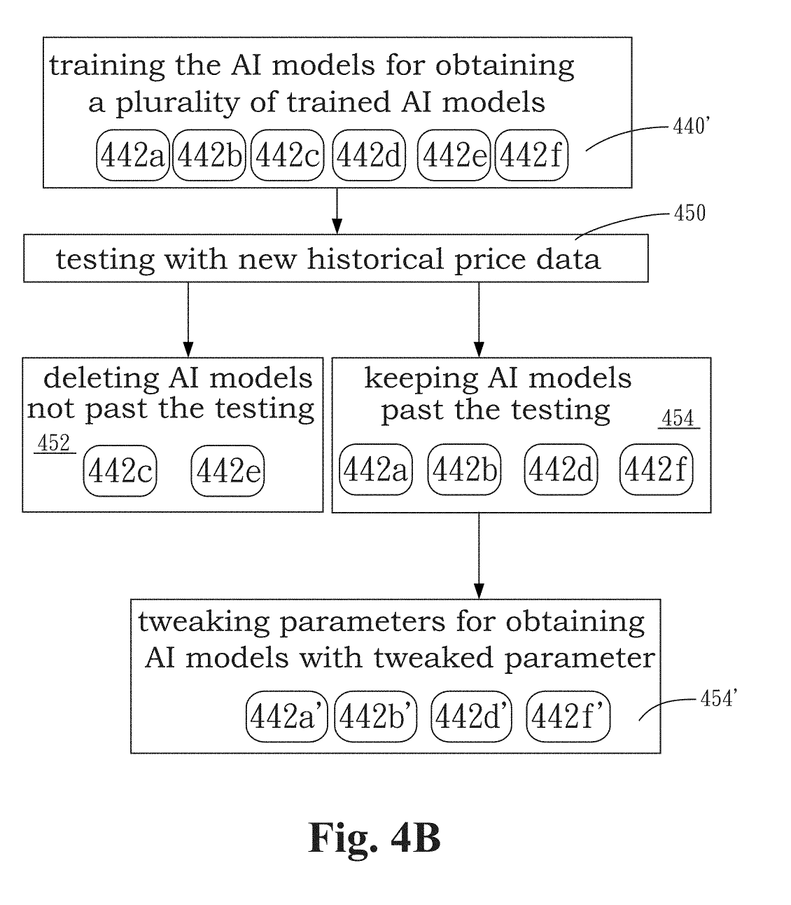

FIG. 5 shows a cumulative returns graph of a portfolio of the financial risk forecast system with AI models and passive market benchmark/S&P500. The sampling time of FIG. 5 is from Jan. 6, 2016 to Jan. 31, 2018. The lower curve (the thinner line) in FIG. 5 shows the cumulative returns graph of passive market benchmark/S&P500 [Equity (22148[OEF]). The upper curve (the thicker line) in FIG. 5 shows the cumulative returns graph of the portfolio of the financial risk forecast system with AI models. It can be found from FIG. 5 that the cumulative returns of the portfolio of the financial risk forecast system with AI models is much better than the cumulative returns of passive market benchmark/S&P500 because of the accurate prediction to financial instrument risk forecast generated by the financial risk forecast system with AI models of this present example.

Therefore, based on the technology disclosed in this specification, investment team of financial institution can focus on risk management, and portfolio optimization and future quantitative risk forecast can be perfectly integrated.

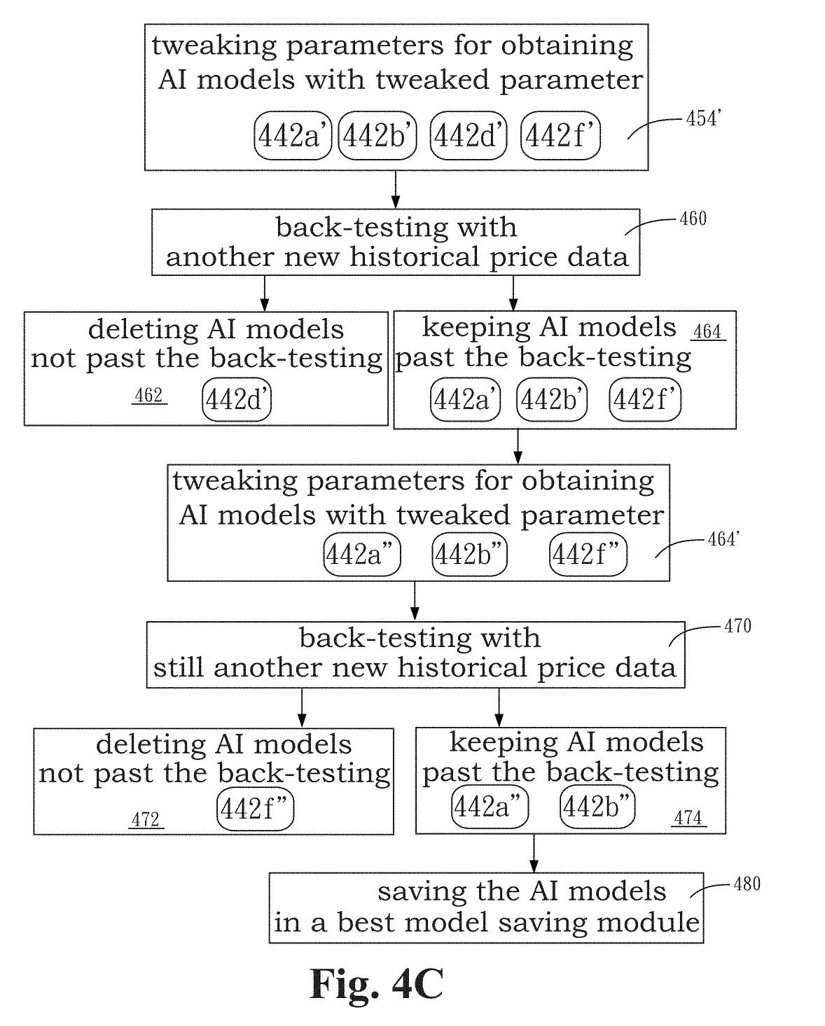

In one preferred example of this specification, the financial risk forecast system with AI models can be used for forecasting market volatility. FIG. 6 shows volatility graph of volatility prediction of the financial risk forecast system with AI models of this specification versus real market volatility. In this example, as shown in FIG. 6, the training set of the AI model is collected from the historical information 900 trading days before November 2017, and the trained AI models are used to predict the 3-day-ahead volatility from a given date. From FIG. 6, it can be expected that the AI models perform well on the volatility prediction for the in-sample data as the AI models are directly learning patterns from the data set.

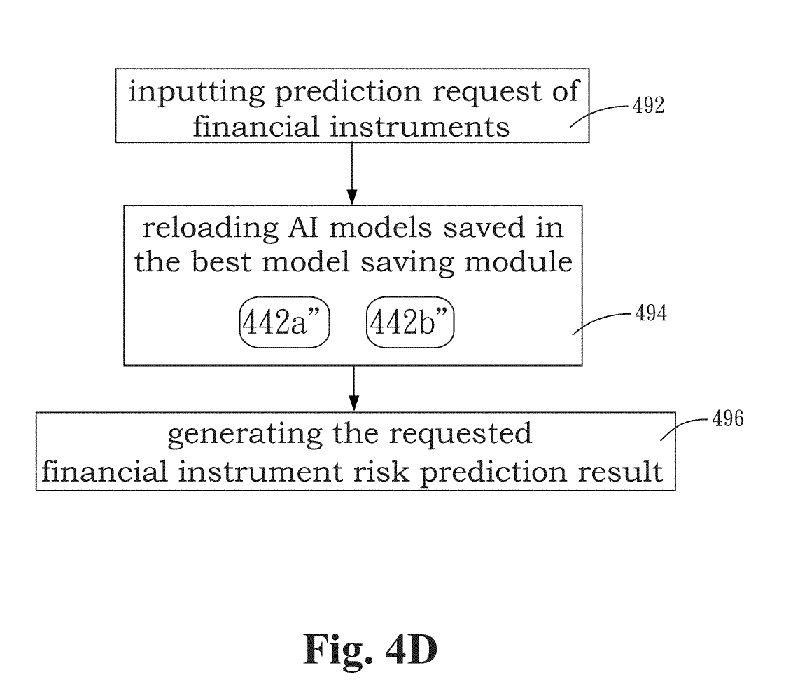

In another preferred example of this specification, a fixed training data set is used for observing how the AI model is learning and fitting AI model to the data over time (‘epochs’). In this example, the “training loss” is the difference between model prediction and the actual data label. For instance, for a specific observation, the AI model may output a volatility of 0.25 (25%), and the actual volatility is 0.27. In the mentioned case, the “model loss” is 0.02. The lower the model loss is, the more the AI model has learned from the data. i.e., the lower the better. FIG. 7 shows the graph of aggregation of the model losses. In FIG. 7, the lower curve shows the train curve of AI model, and the upper curve shows the test curve of AI model. From FIG. 7, it can be found that as the number of epochs increases, the AI model (for “train” curve) learns more and more details from the data, so the model loss decreases over time. The “test” curve is included as a demonstration for the unstable nature of financial data. It is a challenge commonly faced by financial modeling. Overall, if both train model loss and test model loss go down as epoch increases, it can be assumed the AI model is picking up “true patterns” and not just noises from the data. The financial risk forecast system with AI models of this specification then can pick the best model pertaining to a separate “validation set”.

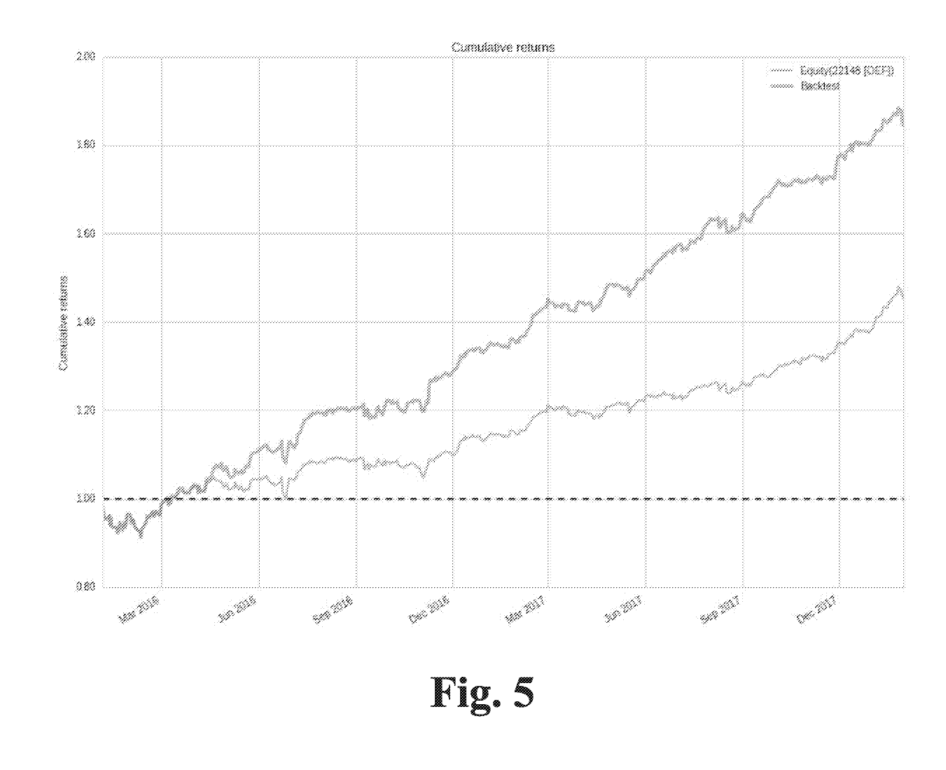

In still another preferred example of this specification, a validation of reconstruction error is performed on AI models of the financial risk forecast system with AI models of this specification. FIG. 8 shows an example of performing validation on the AI models of the financial risk forecast system with AI models of this specification. In this example, as shown in FIG. 8, the AI models are trained on a training set (915 days of data), and are validated on validation data (20 days of data), which is out-of-sample. If a specific model performs well on the Validation set, i.e. lower “reconstruction error”, then the model is saved and used to predict for test data. Overall, if the “mean” for training data and the mean for test data are similar, then the model performs well.

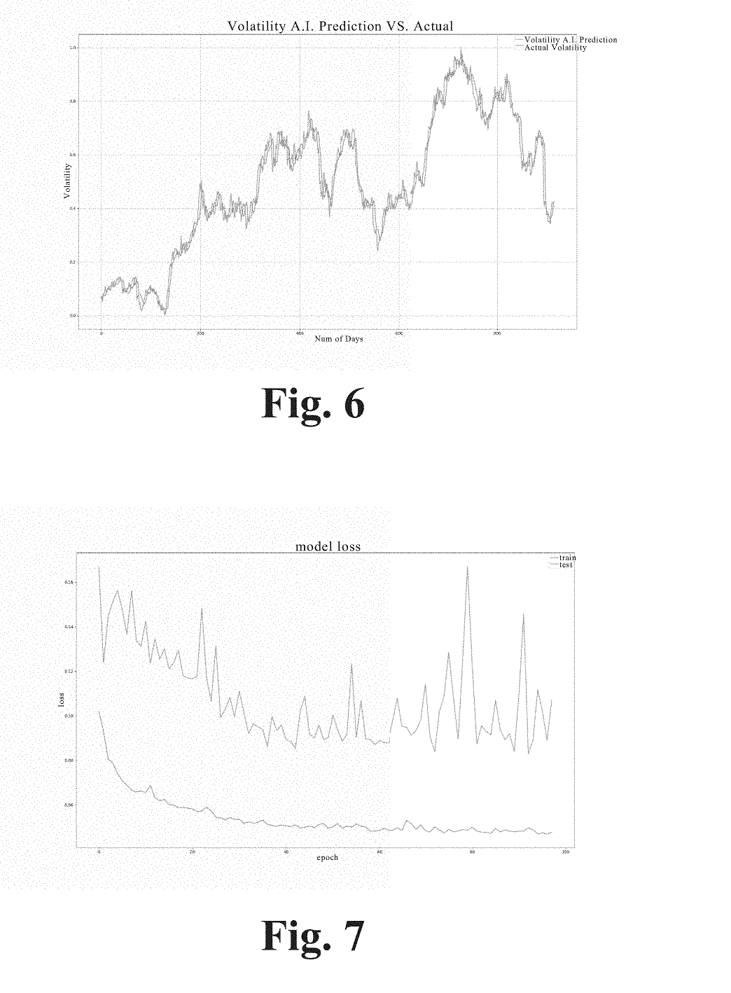

In still another example of this specification, the AI models of this specification and the base models are used for calculating model loss on the “test data/true performance”. FIG. 9 shows a table of comparing the model loss on the “test data-true performance” for each model of the AI models of the financial risk forecast system with AI models of this specification and the base models. The base models are basic LSTM models with one neuron. From FIG. 9, it can be found that out of the 20 models trained separately, the AI models of this specification outperform the base models 75% of time in terms of achieving low model loss.

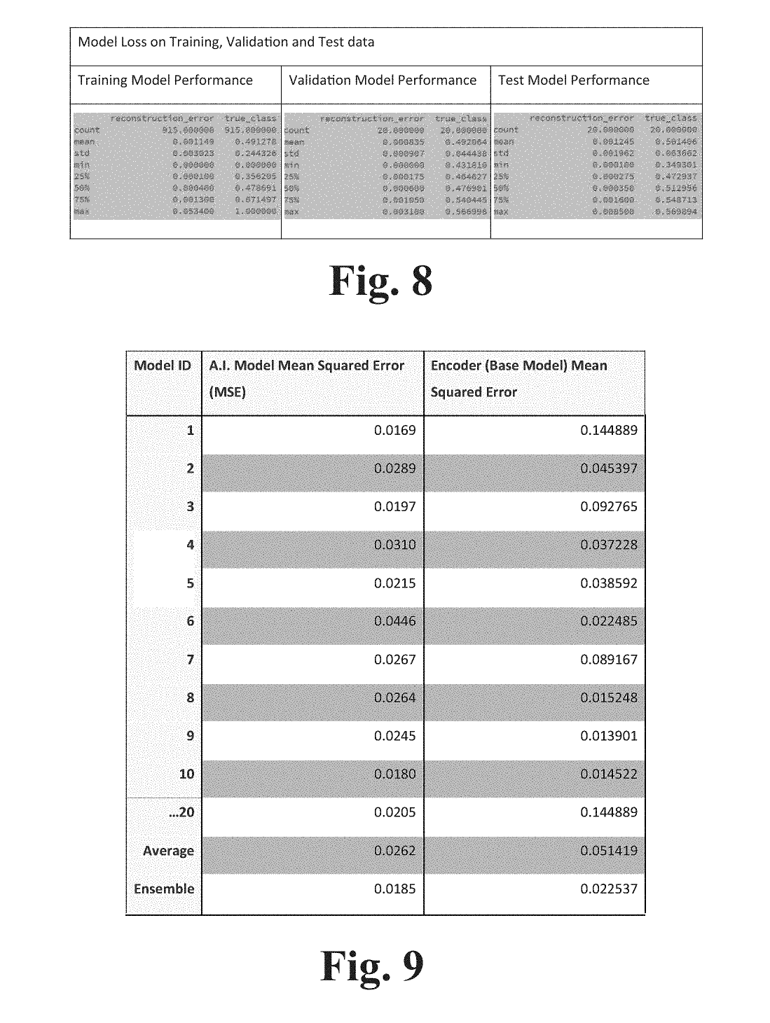

In still another example of this specification, the AI models of the financial risk forecast system with AI models of this specification is used to predict a financial instrument. FIG. 10 shows the graph of the volatility AI prediction of the financial risk forecast system with AI models of this specification and the actual volatility. From FIG. 10, it can be found that the model prediction overall tracks the actual volatility.

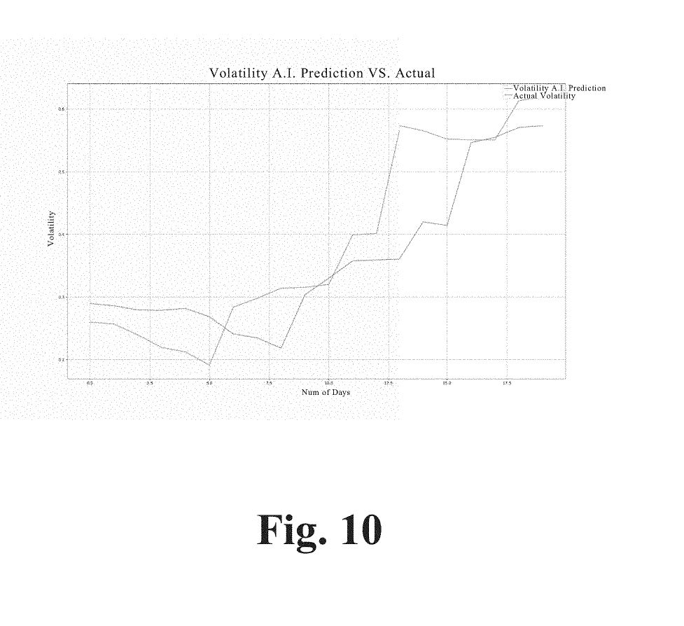

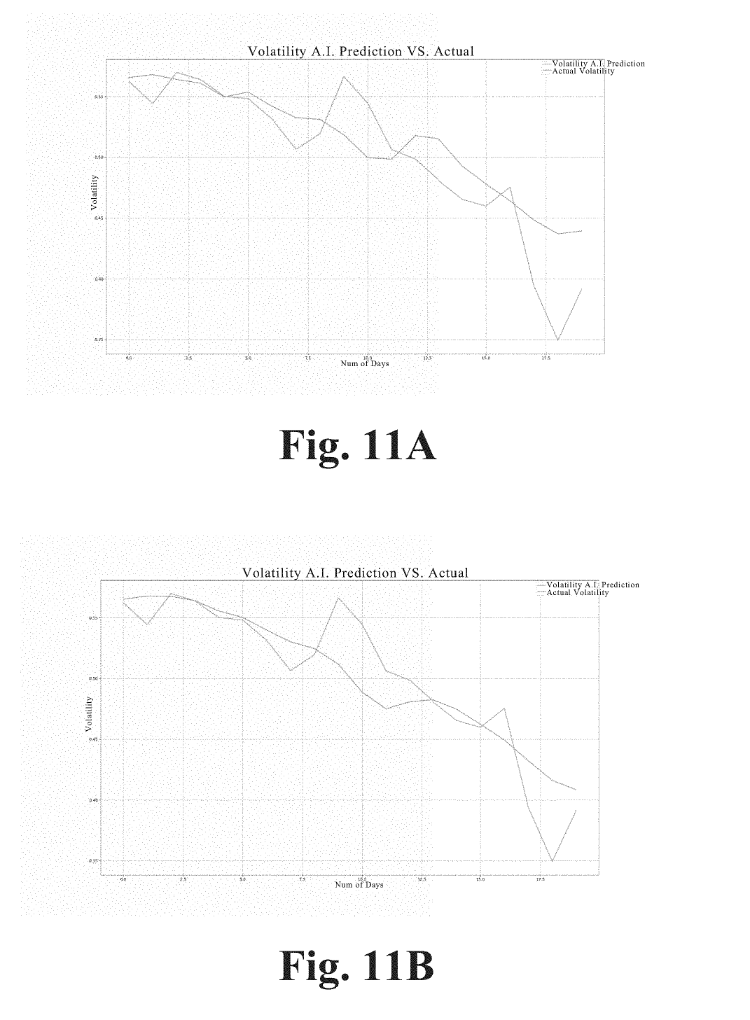

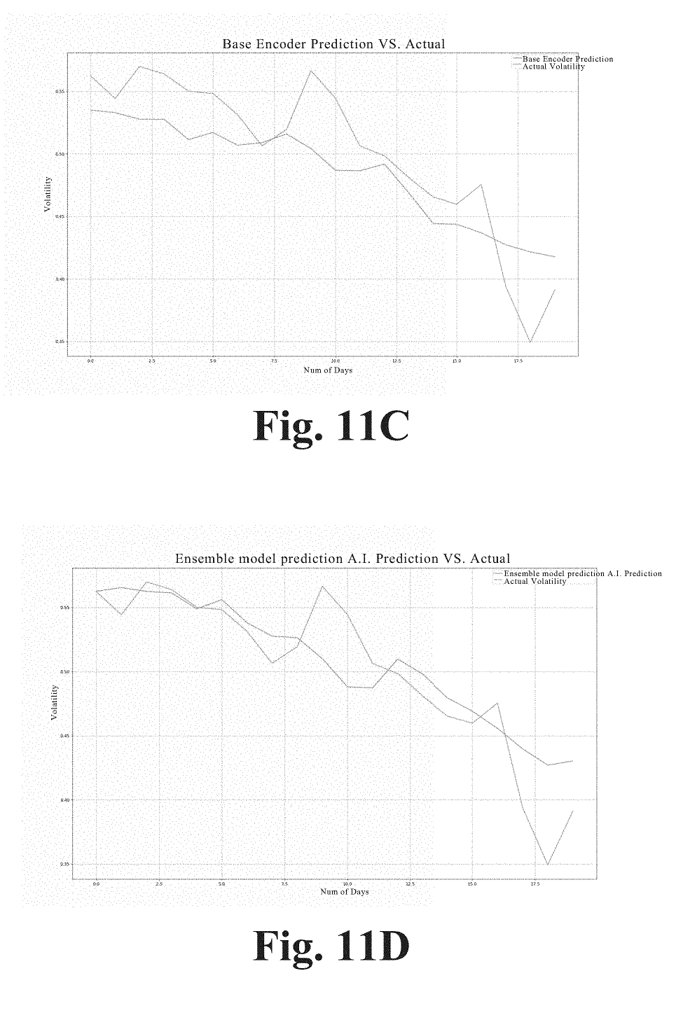

In still another example of this specification, different AI models of the financial risk forecast system with AI models of this specification are used to output based on the same data set. FIG. 11A and FIG. 11B respectively show the graph of volatility of AI models output based on the same data set versus actual volatility. For AI modeling of this specification, each time a model is trained, one will get different model performance. This is because the original training parameters are randomly generated. For high-dimensional non-linear modeling, optimization is not a simple convex problem. That is, there are no easy global minima for minimizing the model loss. From FIG. 11A and FIG. 11B, it can be found how two AI models will have different predictions for the same set of data. Therefore, the financial risk forecast system with AI models of this specification can combine hundreds of such AI models to produce “ensemble predictions”, which have shown to produce superior performance lean towards the best possible model performance consistently.

On the other hand, FIG. 11C shows the graph of the volatility prediction of basic encoder versus actual volatility of a financial instrument. The basic encoder is with multivariate regression with the same data set. From FIG. 11C, the prediction of the basic encoder is less sensitive than the above-mentioned prediction of the AI models of this specification, and the prediction of the basic encoder makes more mistakes at turning points.

FIG. 11D demonstrates the graph depicting an ensemble prediction performance of the financial risk forecast system with AI models of this specification against the actual performance of financial instrument volatility. From FIG. 11D, it demonstrates the combined power and the ensemble prediction of the AI models of this specification.

According to this specification, the advantage of the mentioned financial risk forecast system with AI models and the method thereof compared to current existing methodology include:

1. Differencing model architecture;

2. Differencing methods;

3. Output level adjustments;

4. Sequential learning;

5. Data and financial solution acquisition;

6. Hardware acquisition and cloud-based (such as Amazon Web Services; AWS) computing environment cost-down;

7. Project management professional and administrative staff capable of project management, with sufficient financial background for data vender evaluation, software/cloud-based solution development monitoring and solution version evaluation;

8. Compensate project-based data scientist, researcher, etc.; and

9. Software developer (internal or external) for long-term.

The mentioned financial risk forecast system with AI models of this specification focuses on three points as the following:

A. Individual asset risk forecasts and simulations that are deep learning-driven and does not rely on conventional Monte Carlo method.

B. Optimized portfolio weights that are based on forward forecasts as predicted by complex time series AI models.

C. Automatic and efficient back-test for verification based on the new methodologies and various portfolio constructions to assist decision making.

In one preferred example of this specification, the financial risk forecast system with AI models can simultaneously input a plurality of data features into RNN, and build multiple set of plurality of AI models from the output of RNN. After model filtering with model testing, parameter tweaking, and back-testing, a plurality of the best AI models are obtained. The mentioned plurality of best models can be used for generating future risk prediction for portfolios.

This forecast risk of the financial risk forecast system with AI models of this specification can improve the Sharpe Ratio by 15% compared to current methodology such as equal-weighted portfolio or mean-variance optimization models. If properly utilized, the mentioned financial risk forecast system with AI models should match the market benchmark in its respective market and will lower the volatility by 10% (compared to conventional methodologies) from the original level.

According to this specification, the list development of the financial risk forecast system with AI models includes the followings:

1. Identifying areas in the current Portfolio Construction/Risk Management that could be enhanced using Machine Learning;

2. Forging the methodology and potential theoretical solution to identified weak areas;

3. Constructing the required data infrastructure to support the machine learning development;

4. Developing the models and training them using the data provided;

5. Backtest the models using generated outputs against historical data;

6. Build the infrastructure to automate data management, model training, output generation and output storage; and

7. Developing “client” interfaces to load and present the outputs from the models (GUI, Rest API).

In summary, we have reported a financial risk forecast system and the method thereof with artificial intelligence. The mentioned financial risk forecast system and the method thereof can use multi-layer perception (deep neural network) and recurrent neural network model structure to generate more accurate risk predictions of financial instruments. The mentioned financial risk forecast system and the method thereof comprises collecting financial data and building data repository with a data importing unit, building and training plurality of artificial intelligence models with a model building unit, filtering the plurality of artificial intelligence models by performing testing and at least one back-testing onto the artificial intelligence models with a model filtering unit, tweaking parameters of each of those artificial intelligence models past testing/back-testing with a parameter tweaking module, and saving plurality of the artificial intelligence models after tweaking parameters with a saving module. Lastly, the mentioned financial risk forecast system and the method thereof can display the comparable risk forecasts for any given number of financial instruments by the saved plurality of artificial intelligence models with the best performing testing result. According to this specification, financial institutions can efficiently structure portfolios that incorporate the potential increase/decrease of future instrument volatilities and appropriate hedging/diversification.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

1. A financial risk forecast system with artificial intelligence, comprising:
data importing unit, wherein said data importing unit comprises a data collecting module, a data repository, and a feature extracting module, wherein said data collecting module is used for collecting data and the data collected by said data collecting module is saved in said data repository, wherein said feature extracting module is used for extracting features of the data collected by said data collecting module and for saving the features in said data repository;
model building unit, wherein said model building unit comprises a neural network module, and a saving module, wherein the features extracted by said feature extracting module are used as input of said neural network module, wherein output of said neural network module is used to build a plurality of artificial intelligence models, wherein the plurality of artificial models are saved in said saving module;
model filtering unit, wherein said model filtering unit comprises a model testing module, a parameter tweaking module, a back-testing module, and a best model saving module, wherein said model testing module is used for testing the plurality of artificial intelligence models, wherein said parameter tweaking module is used for tweaking parameters of a plurality of artificial intelligence models past the testing of said model testing module based on testing results generated by the plurality of artificial intelligence models in the testing, wherein a plurality of artificial intelligence models with tweaked parameter obtained in said parameter tweaking module is performed at least one back-testing by said back-testing module, wherein after every back-testing, a plurality of artificial intelligence models past the back-testing are performed parameter tweaking by said parameter tweaking module based on back-testing results generated by the plurality of artificial intelligence models in the back-testing, wherein at least one artificial intelligence model past back-testing and parameter tweaking is saved in said best model saving module; and
prediction generating unit, wherein said prediction generating unit comprises an inputting interface and an outputting interface, wherein said inputting interface is used to input prediction request of financial instruments, wherein the at least one artificial intelligence model saved in said best model saving module is reloaded for generating prediction based on the input prediction request of financial instruments, wherein the prediction generated by the at least one artificial intelligence model is displayed by said outputting interface.

2. The financial risk forecast system with artificial intelligence according to claim 1, wherein said model building unit further comprises an optimizing module, wherein said optimizing module is used for optimizing the plurality of artificial models before the plurality of artificial models is saved in said saving module.

3. The financial risk forecast system with artificial intelligence according to claim 2, wherein said optimizing module is used for optimizing the plurality of artificial models by Adam Optimization Algorithm.

4. The financial risk forecast system with artificial intelligence according to claim 1, wherein said neural network module is recurrent neural networks (RNN).

5. The financial risk forecast system with artificial intelligence according to claim 1, wherein said neural network module is long-short term memory (LSTM).

6. The financial risk forecast system with artificial intelligence according to claim 1, wherein said data collecting module is used for collecting the data from data sources selected from the group consisted of: adjusted historical data, fundamental data, macro data, live feeds, financial reports, social media data and satellite images.

7. A financial risk forecast method with artificial intelligence, wherein said financial risk forecast method is used for a financial risk forecast system, comprising:
collecting data for building a data repository, wherein the data saved in the data repository is collected and maintained up to date by a data collecting module, wherein features of the data saved in the data repository are extracted by a feature extracting module and are saved in the data repository;
building a plurality of artificial intelligence models, wherein the features are employed as input of a neural network module, and output of the neural network module is used to build the plurality of artificial intelligence models;
filtering the plurality of artificial intelligence models, wherein the plurality of artificial intelligence models is performed a test by a model testing module for producing at least one artificial intelligence model past the test, wherein the at least one artificial intelligence model past the test is performed parameter tweaking based on testing result of the at least one artificial intelligence model past the test by a parameter tweaking module for producing at least one artificial intelligence model with tweaked parameter, wherein the at least one artificial intelligence model with tweaked parameter is performed at least one back-testing for producing at least one artificial intelligence model past the back-testing, wherein at least one artificial intelligence model past the back-testing, after every back-testing, is performed parameter tweaking based on back-testing result of the at least one artificial intelligence model past the back-test by the parameter tweaking module for producing at least one best artificial intelligence model, wherein the at least one best artificial intelligence model is saved in a best model saving module; and
generating prediction of financial instruments, wherein the at least one best artificial intelligence model saved in the best model saving module is reloaded for generating prediction of financial instruments based on input prediction request of financial instruments from an inputting interface, wherein the prediction generated by the at least one best artificial intelligence model is displayed by an outputting interface.

8. The financial risk forecast method with artificial intelligence according to claim 7, wherein the neural network module is recurrent neural networks (RNN).

9. The financial risk forecast method with artificial intelligence according to claim 7, wherein the neural network module is long-short term memory (LSTM).

10. The financial risk forecast system with artificial intelligence according to claim 7, wherein the data collecting module is used for collecting the data from data sources selected from the group consisted of: adjusted historical data, fundamental data, macro data, live feeds, financial reports, social media data and satellite images.
